(19) United States
(12) Patent Application Publication
(10) Pub. No.: US 2014/0162053 A1
(43) Pub. Date: Jun. 12, 2014

(54) BONDED SUBSTRATE STRUCTURE USING SILOXANE-BASED MONOMER AND METHOD OF MANUFACTURING THE SAME

(71) Applicant: SAMSUNG ELECTRONICS CO., LTD., Suwon-Si (KR)

(72) Inventors: Jeong-yub LEE, Seoul (KR); Xianyu WENXU, Suwon-si (KR); Jun-sik HWANG, Hwaseong-si (KR); Chang-youl MOON, Suwon-si (KR)

(73) Assignee: SAMSUNG ELECTRONICS CO., LTD., Suwon-Si (KR)

(21) Appl. No.: 13/866,389

(22) Filed: Apr. 19, 2013

(30) Foreign Application Priority Data
Dec. 12, 2012 (KR) 10-2012-0144807

(51) Int. Cl. B32B 7/12; B32B 37/12; B32B 38/00

(52) U.S. Cl. CPC B32B 7/12; B32B 38/0008; B32B 37/12
USPC 428/336; 428/447; 156/281; 156/272.6

(57) ABSTRACT

A bonded substrate structure includes a siloxane-based monomer layer between a first substrate and a second substrate, the siloxane-based monomer layer bonding the first substrate and the second substrate. The first substrate and the second substrate may be one of a silicon substrate and a silicon oxide substrate, respectively.

### CROSS-REFERENCE TO RELATED APPLICATIONS

This application claims the benefit of Korean Patent Application No. 10-2012-0144807, filed on Dec. 12, 2012, in the Korean Intellectual Property Office, the disclosure of which is incorporated herein in its entirety by reference.

### BACKGROUND

1. Field

Some example embodiments relate to substrate structures formed by bonding two substrates by using a siloxane-based monomer and methods of manufacturing the substrate structure.

2. Description of the Related Art

When including graphene on a wafer, wafer-bonding at a temperature of about 100° C. or less is necessary and a wafer-bonded structure after bonding is required not to be deformed at a relatively high temperature of about 900° C. or more to perform an electrode forming process. Also, on a bonding interface, it is necessary to form an insulating material to prevent or inhibit an electric leakage.

In general, to bond two wafers, an epoxy-based bonding agent, a urethane-based bonding agent, and a silicone-based bonding agent are used. Such a bonding agent is applied to a wafer and then another wafer is closely attached thereto, thereby bonding the wafers. Due to a difference between thermal-expansion coefficients of the bonding agent and the wafers and a relatively large thickness of the bonding agent, a structure bonded at higher temperatures may be bent. Also, a bonding strength may be lower and a curing time at lower temperatures may be increased.

### SUMMARY

Some example embodiments provide bonded structures formed by bonding wafers at lower temperatures by using a siloxane-based monomer with a relatively high bonding strength therebetween.

Additional aspects will be set forth in part in the description which follows and, in part, will be apparent from the description, or may be learned by practice of the presented embodiments.

According to an example embodiment, a bonded substrate structure includes a siloxane-based monomer layer between a first substrate and a second substrate, the siloxane-based monomer layer bonding the first substrate and the second substrate.

The siloxane-based monomer layer may be one of dimethyl siloxanes, methyl-phenyl siloxanes, and methyl-vinyl siloxanes. The siloxane-based monomer layer may have a thickness of from about 1 to about 30 nm.

The structure may further include a plurality of first dangling bonds on a top surface of the first substrate, the plurality of first dangling bonds being bonded to the siloxane-based monomer layer, and a plurality of second dangling bonds on a surface of the siloxane-based monomer, the plurality of second dangling bonds being bonded to the second substrate. The plurality of first dangling bonds and the plurality of second dangling bonds may be formed by oxygen plasma.

The first substrate and the second substrate may be one of a silicon substrate and a silicon oxide substrate. At least one of the first substrate and the second substrate may include one of a silicon layer and a silicon oxide layer on a surface thereof. The at least one of the first substrate and the second substrate may include one of Group III-V semiconductors, metal, and plastic.

According to example embodiments, a method of manufacturing a bonded substrate structure includes forming a plurality of first dangling bonds on a first surface of a first substrate using a surface treatment process, applying a siloxane liquid onto the first surface, cleaning the first surface to form a siloxane-based monomer layer bonded to the plurality of first dangling bonds on the first surface, forming a plurality of second dangling bonds on one of a surface of the siloxane-based monomer layer and a second surface of a second substrate, and bonding the second substrate to the siloxane-based monomer layer.

The plurality of first dangling bonds may be formed by treating the first surface with oxygen plasma. The siloxane liquid may be at least one of dimethyl siloxanes, methyl-phenyl siloxanes, and methyl-vinyl siloxanes. Applying the siloxane liquid may further include curing the siloxane liquid. The plurality of second dangling bonds may be formed on the surface of the siloxane-based monomer layer by treating the surface of the siloxane-based monomer layer with oxygen plasma. The plurality of second dangling bonds may be formed on the second surface of the second substrate by treating the second surface of the second substrate with oxygen plasma. The second substrate may be bonded to the siloxane-based monomer layer by applying mechanical pressure to the first substrate and the second substrate in a vacuum chamber.

The first substrate and the second substrate may be one of a silicon substrate and a silicon oxide substrate. At least one of the first substrate and the second substrate may include one of a silicon layer and a silicon oxide layer on a surface thereof. The at least one of the first substrate and the second substrate may include one of Group III-V semiconductors, metal, and plastic.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic view illustrating a bonded substrate structure using a siloxane-based monomer, according to an example embodiment;

FIG. 2 is a cross-sectional view schematically illustrating a bonded substrate structure using a siloxane-based monomer, according to another example embodiment;

FIGS. 3A to 3G are views illustrating a method of manufacturing a bonded substrate structure using a siloxane-based monomer, according to still another example embodiment; and

FIGS. 4A to 4F are views illustrating operations of a method of manufacturing a bonded substrate structure using a siloxane-based monomer, according to yet another example embodiment.

### DETAILED DESCRIPTION

Reference will now be made in detail to embodiments, examples of which are illustrated in the accompanying drawings, wherein a size of an element may be exaggerated for clarity and convenience of description. In the drawings, like reference numerals refer to the like elements throughout. A detailed description thereof will not be repeated.

Hereinafter, expressions such as “above” or “on” may not only indicate being disposed right on top and in direct contact with something but may also indicate being disposed above without any contact therewith. Expressions such as “at least one of,” when preceding a list of elements, modify the entire list of elements and do not modify the individual elements of the list.

It will be understood that, although the terms “first”, “second”, etc. may be used herein to describe various elements, components, regions, layers and/or sections, these elements, components, regions, layers and/or sections are not to be limited by these terms. These terms are only used to distinguish one element, component, region, laver or section from another element, component, region, laver or section. Thus, a first element, component, region, laver or section discussed below could be termed a second element, component, region, laver or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments are not to be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, is to be interpreted as having a meaning that is consistent with their meaning in the context of the relevant art and will not be interpreted in an idealized or overly formal sense unless expressly so defined herein.

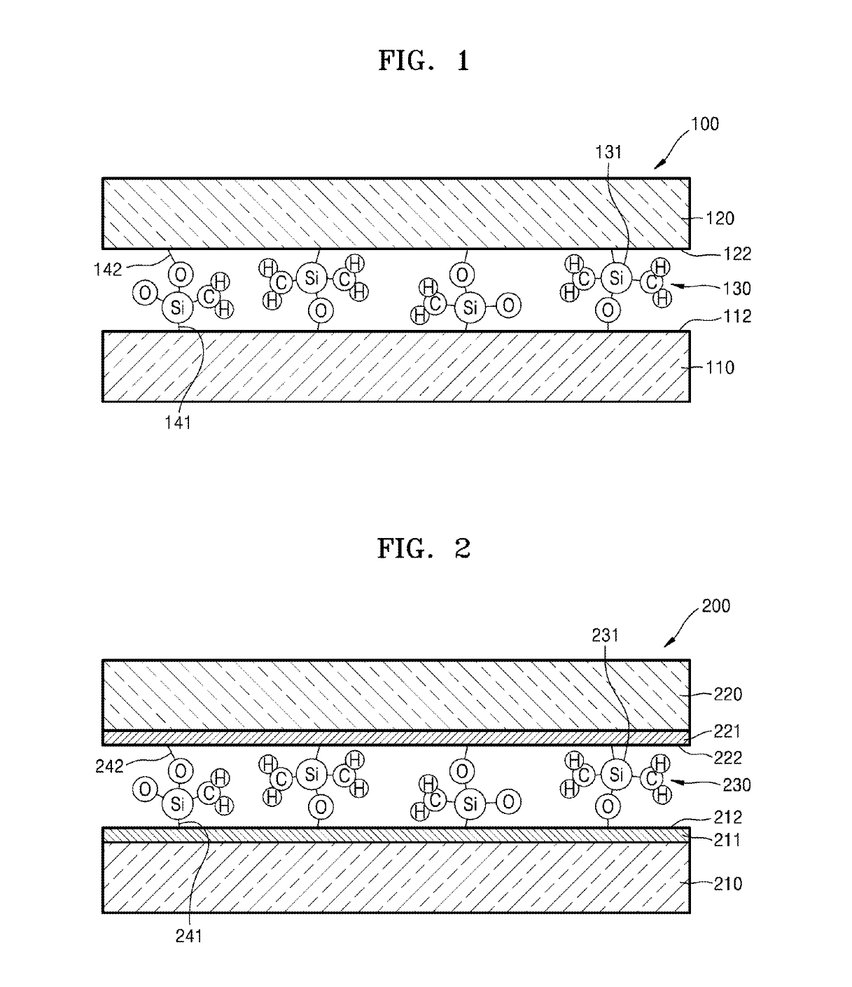

FIG. 1 is a schematic view illustrating a bonded substrate structure 100 using a siloxane-based monomer, according to an example embodiment. Referring to FIG. 1, a siloxane-based monomer layer 130 is interposed between two wafers. Hereinafter, for convenience of description, a wafer is also designated as a substrate. The siloxane-based monomer layer 130 is attached onto a first substrate 110, and a second substrate 120 is attached onto the siloxane-based monomer layer 130. The first substrate 110 and the second substrate 120 may be one of a silicon substrate and a silicon oxide substrate, respectively. Also, the first substrate 110 and the second substrate 120 may be silicon substrates with a silicon oxide layer thereon.

A first surface 112 that is a top surface of the first substrate 110 is treated with oxygen plasma in such a way that a plurality of first dangling bonds 141 are formed on the first surface 112. The plurality of first dangling bonds 141 are covalently bonded to siloxane-base monomers of the siloxane-based monomer layer 130. Due to these covalent bonds, the siloxane-based monomer layer 130 is strongly attached to the first substrate 110.

The siloxane-based monomer layer 130 may be formed of dimethyl siloxanes, methyl-phenyl siloxanes, and methyl-vinyl siloxanes. In FIG. 1, the siloxane-based monomer layer 130 formed of dimethyl siloxanes is shown.

When being formed of one monomer, the siloxane-based monomer layer 130 is formed to have a thickness of about 1 nm. The siloxane-based monomer layer 130 may be formed of linear chain monomers. When being formed of about 30 linear chains, the siloxane-based monomer layer 130 may be formed to have a thickness of about 30 nm. When the siloxane-based monomer layer 130 has a thickness greater than 30 nm, polymer properties are revealed and a deformation of the structure 100 may occur due to thermal expansion.

A surface 131 of the siloxane-based monomer layer 130, closely attached to the second substrate 120, is treated with oxygen plasma to form a plurality of second dangling bonds 142 in such a way that a second surface 122 of the second substrate 120 may be strongly covalently bonded to the plurality of second dangling bonds 142.

The bonded substrate structure 100 has a relatively high bonding strength because two substrates are covalently bonded to the siloxane-based monomer layer 130 therebetween. For example, the structure 100 has a shear strength of 20 MPa or more.

Since the siloxane-based monomer layer 130 between the first substrate 110 and the second substrate 120 has a thickness of several nm to several tens of nm, a problem due to a difference between thermal expansion coefficients of the first and second substrates 110 and 120 and the siloxane-based monomer layer 130 does not arise. Also, since there is no deformation of the siloxane-based monomer layer 130 in a process performed at a relatively high temperature of, for example, 900° C. or more, it is possible to perform a relatively high temperature process on the siloxane-based monomer layer 130.

Also, since the first and second substrates 110 and 120 are closely attached to the siloxane-based monomer layer 130, pollution between the first substrate 110 and the second substrate 120 hardly occurs.

FIG. 2 is a cross-sectional view schematically illustrating a bonded substrate structure 200 using a siloxane-based monomer, according to another example embodiment. Referring to FIG. 2, a siloxane-based monomer layer 230 is interposed between two wafers. Hereinafter, for convenience of description, a wafer is also designated as a substrate.

A first substrate 210 and a second substrate 220 may be non-silicon-based substrates. A first layer 211 formed of one of a silicon layer and a silicon oxide layer is formed on the first substrate 210. The first substrate 210 may be a substrate except one of silicon and silicon oxide. The first substrate 210 may be formed of Group III-V semiconductors such as GaN and GaAs, metal, and plastic. The metal may be, for example, aluminum, copper, and nickel. The plastic may be, for example, polyethylene, polyimide, and polystyrene.

The second substrate 220 may be a substrate except one of silicon and silicon oxide. The second substrate 220 may be formed of Group III-V semiconductors such as GaN and GaAs and metal. A second layer 221 formed of one of a silicon layer and a silicon oxide layer may be formed on the second substrate 220.

The siloxane-based monomer layer 230 is attached onto the first layer 211, and the second layer 221 is attached onto the siloxane-based monomer layer 230.

A first surface 212 of the first layer 211, which is a contact surface, is treated with oxygen plasma in such a way that a plurality of first dangling bonds 241 is formed on the first surface 212. The plurality of first dangling bonds 241 are covalently bonded to siloxane-based monomers of the siloxane-based monomer layer 230. Due to these covalent bonds, the siloxane-based monomer layer 230 is strongly attached to the first substrate 210.

The siloxane-based monomer layer 230 may be formed of dimethyl siloxanes, methyl-phenyl siloxanes, and methyl-vinyl siloxanes. In FIG. 2, the siloxane-based monomer layer 230 formed of dimethyl siloxanes is shown.

When being formed of one monomer, the siloxane-based monomer layer 230 is formed to have a thickness of about 1 nm. The siloxane-based monomer layer 230 may be formed of linear chain monomers. When being formed of about 30 linear chains, the siloxane-based monomer layer 230 may be formed to have a thickness of about 30 nm. When the siloxane-based monomer layer 230 has a thickness greater than 30 nm, polymer properties are revealed and a deformation of the structure 200 may occur due to thermal expansion.

A surface 231 of the siloxane-based monomer layer 230, closely attached to the second layer 221 of the second substrate 120, is treated with oxygen plasma to form a plurality of second dangling bonds 242 in such a way that a second surface 222 of the second layer 221 may be strongly covalently bonded to the plurality of second dangling bonds 242.

The bonded substrate structure 200 may be used to bond non-silicon-based substrates whose contact surfaces include one of a silicon layer and a silicon oxide layer formed thereon, respectively.

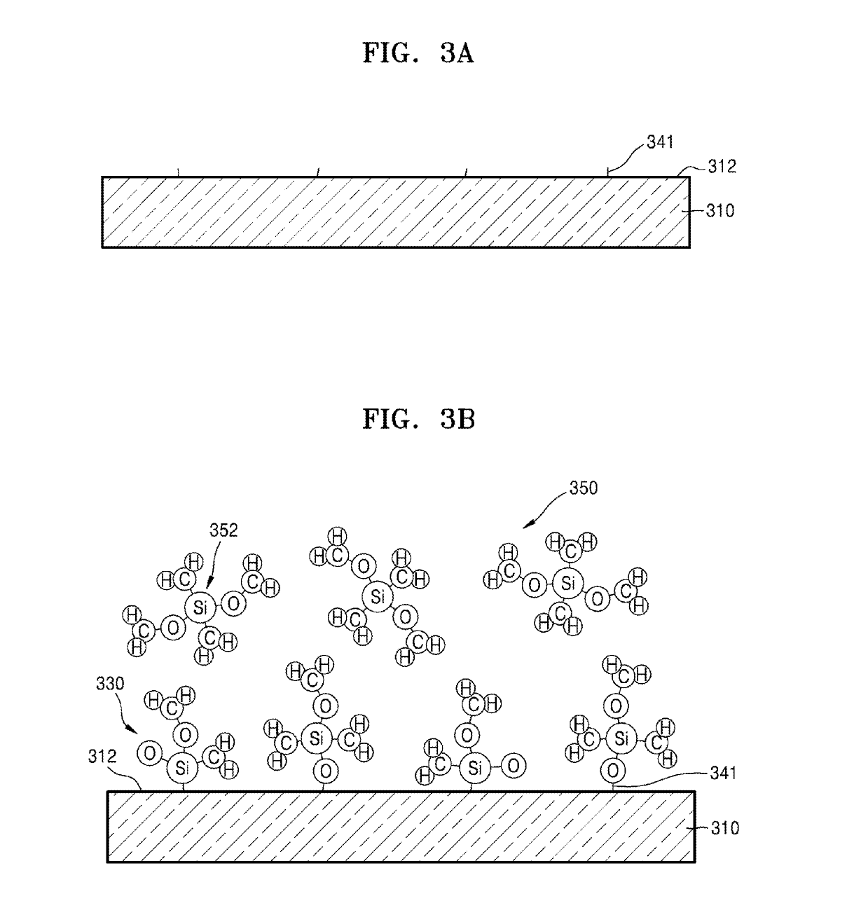

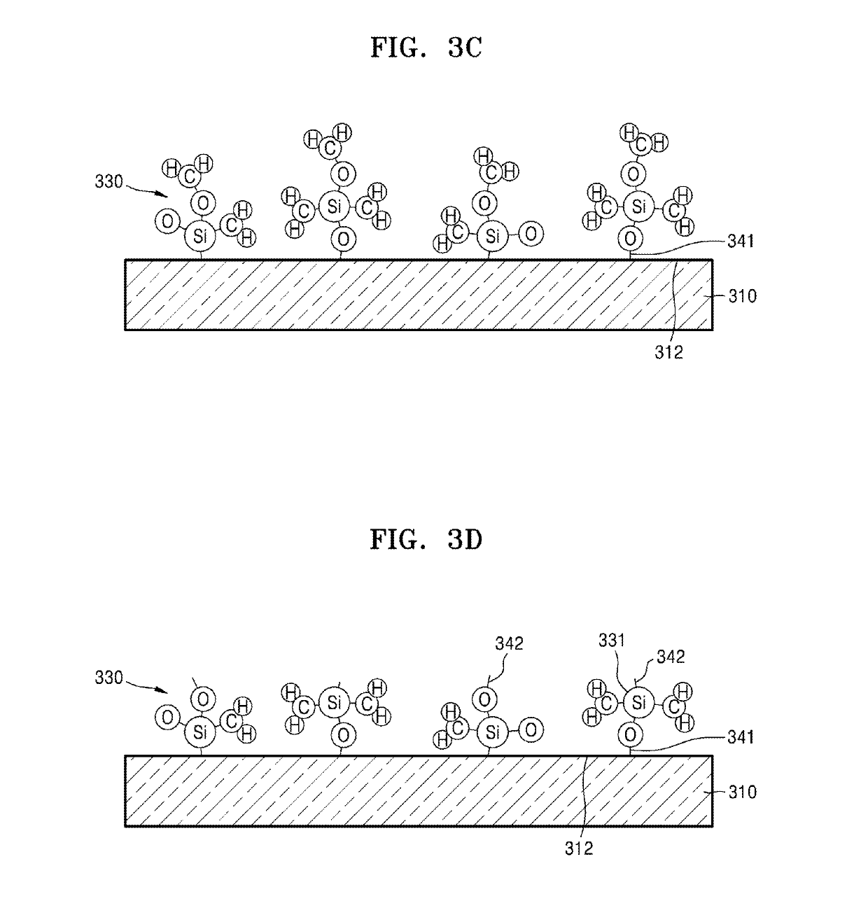

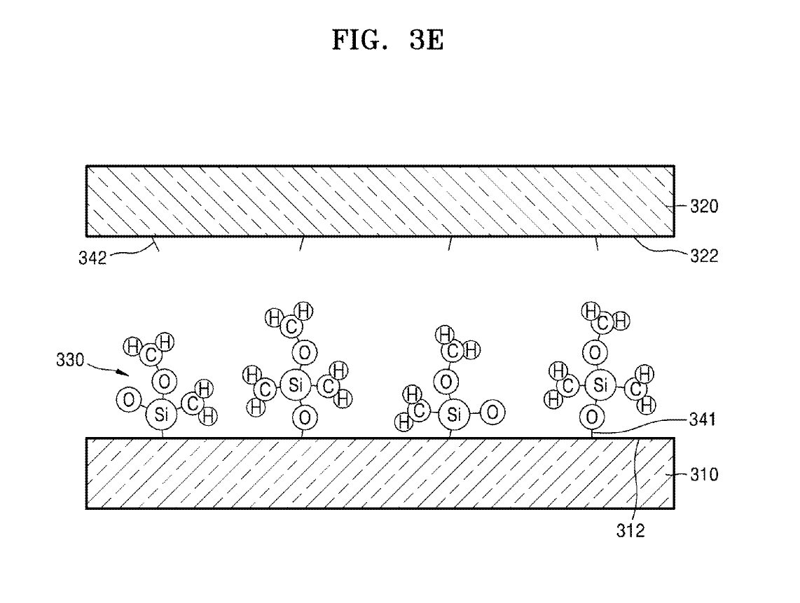

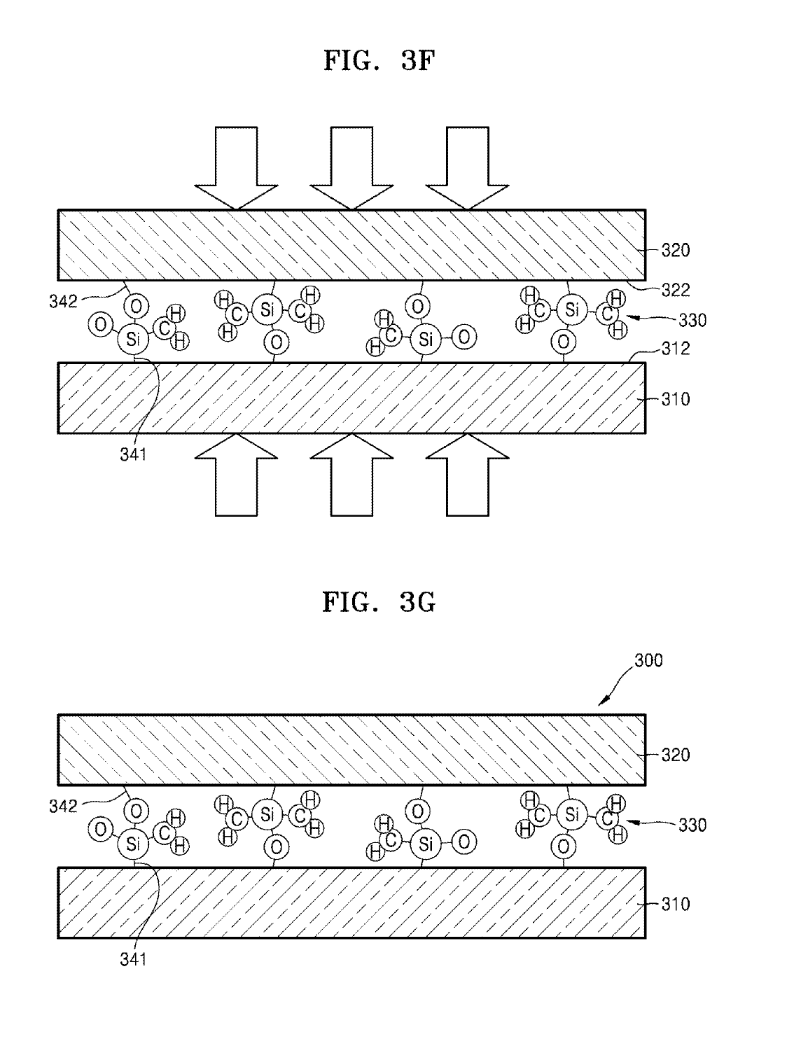

FIGS. 3A to 3G are views illustrating a method of manufacturing a bonded substrate structure 300 using a siloxane-based monomer, according to still another example embodiment. Referring to FIG. 3A, a first substrate 310 is prepared. The first substrate 310 may be formed of one of silicon and silicon oxide. Also, a silicon oxide layer may be formed on a silicon substrate. A first surface 312 of the first substrate 310 is treated with oxygen plasma, thereby forming a plurality of first dangling bonds 341 on the first surface 312.

The oxygen plasma treatment may be performed using power of from about 20 to about 60 W. When the power for the oxygen plasma is lower than 20 W, plasma may not be generated. When the power for the oxygen plasma is higher than 60 W, excessive oxygen is bonded to dangling bonds, thereby reducing the number of the dangling bonds.

Referring to FIG. 3B, a siloxane liquid 350 is applied onto the first surface 312 of the first substrate 310. The siloxane liquid 350 may be formed of dimethyl siloxane monomers, methyl-phenyl siloxane monomers, and methyl-vinyl siloxane monomers. In FIG. 3B, the siloxane liquid 350 formed of dimethyl siloxane monomers is shown.

The first substrate 310 is disposed at room temperature for 24 hours or at a temperature of 80° C. for about an hour to cure the siloxane liquid 350. In the curing process, the siloxane liquid 350 includes a siloxane-based monomer layer 330 covalently bonded to the plurality of first dangling bonds 341 and siloxane-based monomers 352 on the siloxane-based monomer layer 330. The siloxane-based monomers 352 on the siloxane-based monomer layer 330 have a relatively weak bonding force with the siloxane-based monomer layer 330.

Referring to FIG. 3C, the first surface 312 of the first substrate 310 is cleaned by using a mixed solution of acetone and isopropyl alcohol. The siloxane-based monomers 352 having the weak bonding force with the siloxane-based monomer layer 330 are removed from the first substrate 310. As a result thereof, only the siloxane-based monomer layer 330 may be formed on the first surface 312 of the first substrate 310.

When being formed of one monomer, the siloxane-based monomer layer 330 is formed to have a thickness of about 1 nm. The siloxane-based monomer layer 330 may be formed of linear chain monomers. When being formed of about 30 linear chains, the siloxane-based monomer layer 330 may be formed to have a thickness of about 30 nm. When the siloxane-based monomer layer 330 has a thickness greater than 30 nm, polymer properties are revealed and a deformation of the structure 300 may occur due to a difference of thermal expansion coefficients between the siloxane-based monomer layer 330 and the first substrate 310 and the second substrate 320 which will be described later.

Referring to FIG. 3D, a surface 331 of the siloxane-based monomer layer 330 is treated with oxygen plasma. This surface treatment may be performed using power of about 25 W. A plurality of second dangling bonds 342 is formed on the surface 331 of the siloxane-based monomer layer 330.

On the other hand, referring to FIG. 3E, a second surface 322 of a second substrate 320 may be previously treated with oxygen plasma to previously form a plurality of second dangling bonds 342 on the second surface 322 and then the below bonding process may be performed.

Referring to FIG. 3F, while disposing a contact surface that is the second surface 322 of the second substrate 320 to face the first surface 312 of the first substrate 310, mechanical pressure is applied to the first substrate 310 and the second substrate 320 in a direction shown by arrows in a vacuum state of about 2 mtorr to bond the same with each other. The mechanical pressure may be applied for an hour at a force of about 100 N. While bonding in the vacuum state, it is possible to prevent or inhibit bubbles from being formed between the first substrate 310 and the second substrate 320.

Referring to FIG. 3G, a resultant structure is disposed at room temperature for 24 hours or at a temperature of 80° C. for an hour to be cured. In the curing process, the second dangling bonds 342 or third dangling bonds 343 are strongly covalently bonded to the second substrate 320. The first substrate 310 and the second substrate 320 are bonded to each other by the siloxane-based monomer layer 330 therebetween, thereby manufacturing the bonded substrate structure 300 using a siloxane-based monomer.

According to the present embodiment, since substrates are bonded at a low temperature, hot-short materials such as graphene, plastic, and polymer formed on the substrate may not be damaged during the bonding process.

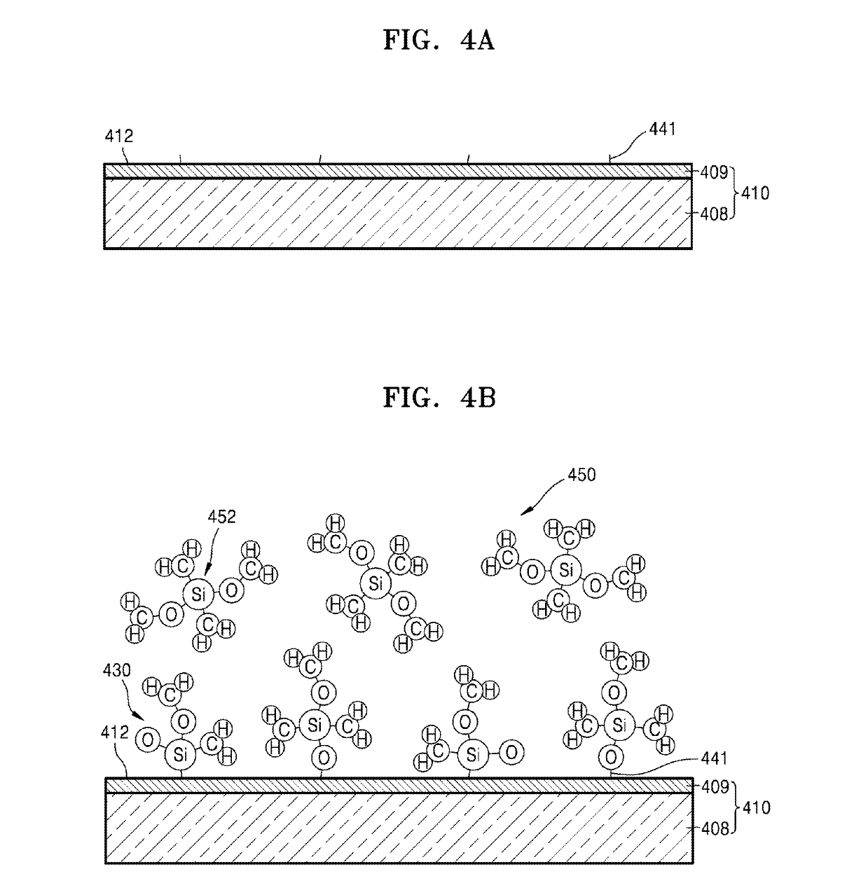

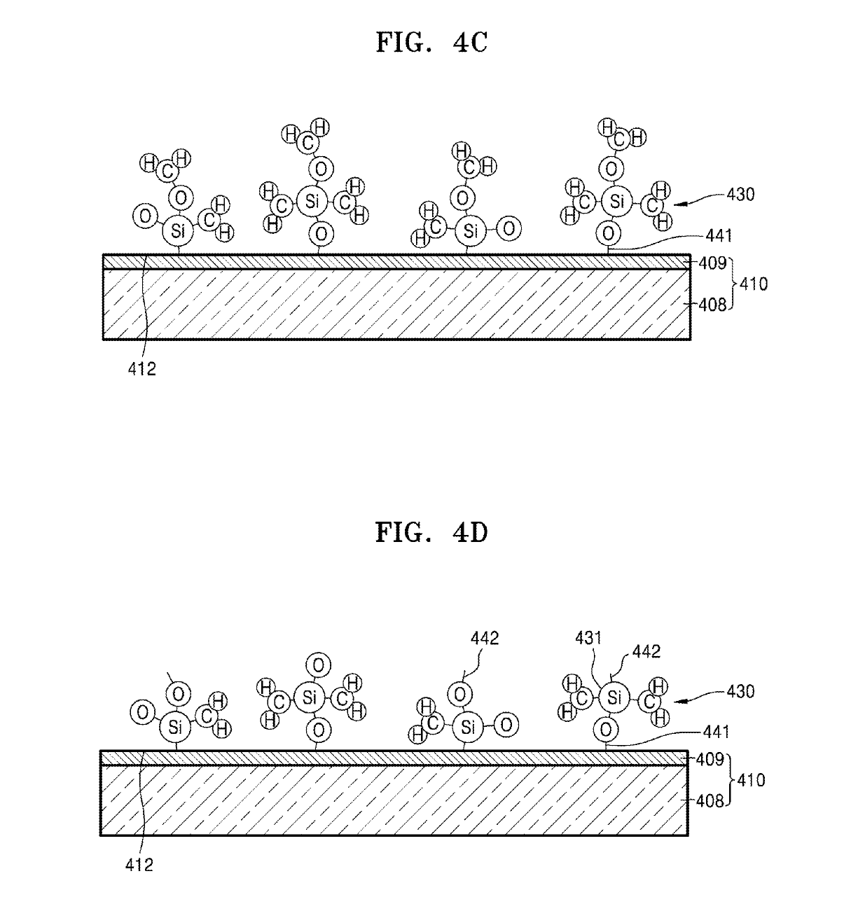

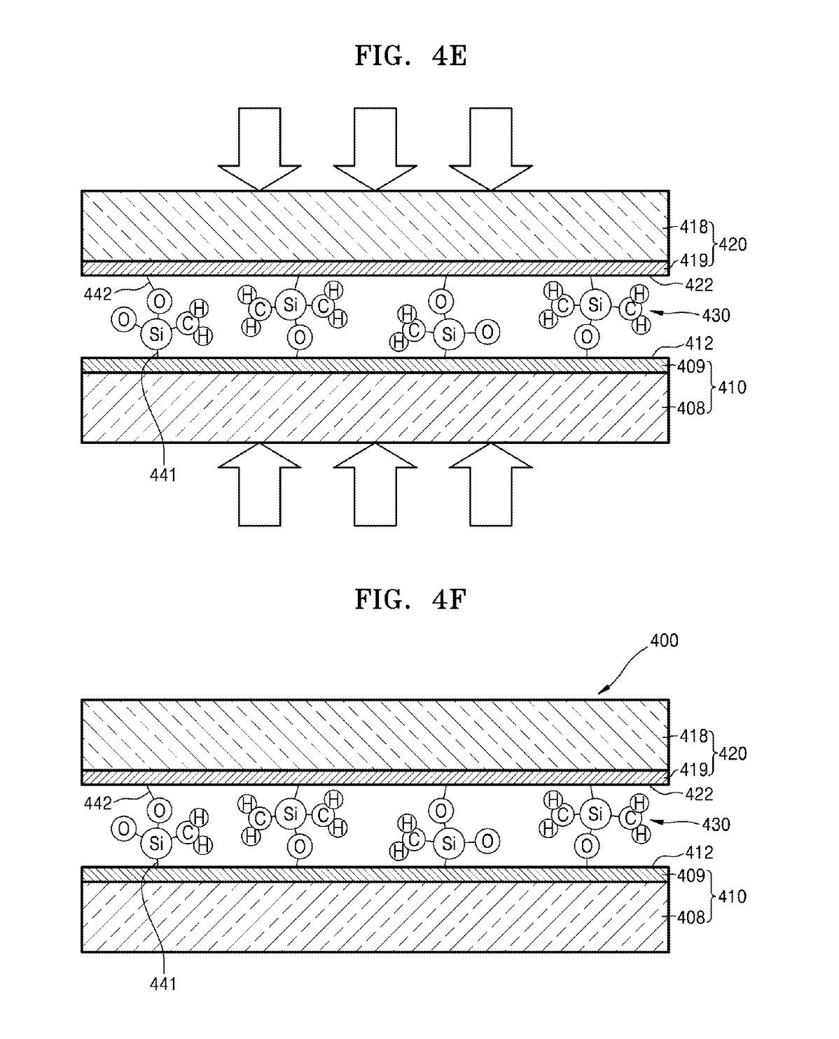

FIGS. 4A to 4F are views illustrating operations of a method of manufacturing a bonded substrate structure 400 using a siloxane-based monomer, according to yet another example embodiment.

Referring to FIG. 4A, a first substrate 410 is prepared. The first substrate 410 includes a non-silicon-based substrate 408 and a first layer 409. The first layer 409 may be formed by depositing one of silicon and silicon oxide on the non-silicon-based substrate 408. As a deposition method, it is possible to use physical vapor deposition (PVD) such as sputtering and evaporation and chemical vapor deposition (CVD). While performing CVD, hydrogen may be generated on a surface of the first substrate 410, and thus, a thermal treatment may be further performed at a temperature of 400° C. or more to remove the hydrogen. The non-silicon-based substrate 408 may be formed of Group III-V semiconductors, metal, or plastic.

A first surface 412 of the first substrate 410 is treated with oxygen plasma, thereby forming a plurality of first dangling bonds 441 on the first surface 412. The oxygen plasma treatment may be performed using power of from about 20 to about 60 W. When the power for the oxygen plasma is lower than 20 W, plasma may not be generated. When the power for the oxygen plasma is higher than 60 W, excessive oxygen is bonded to the dangling bonds, thereby reducing the number of the dangling bonds.

Referring to FIG. 4B, a siloxane liquid 450 is applied onto the first surface 412 of the first substrate 410. The siloxane liquid 450 may be formed of dimethyl siloxane monomers, methyl-phenyl siloxane monomers, and methyl-vinyl siloxane monomers. In FIG. 4B, the siloxane liquid 450 formed of dimethyl siloxane monomers is shown.

The first substrate 410 is disposed at room temperature for 24 hours or at a temperature of 80° C. for about an hour to cure the siloxane liquid 450. In the curing process, the siloxane liquid 450 includes a siloxane-based monomer layer 430 covalently bonded to the plurality of first dangling bonds 441 and siloxane-based monomers 452 on the siloxane-based monomer layer 430. The siloxane-based monomers 452 on the siloxane-based monomer layer 430 have a relatively weak bonding force with the siloxane-based monomer layer 430.

Referring to FIG. 4C, the first surface 412 of the first substrate 410 is cleaned by using a mixed solution of acetone and isopropyl alcohol. The siloxane-based monomers 452 having the weak bonding force with the siloxane-based monomer layer 430 are removed from the first substrate 410. As a result thereof, only the siloxane-based monomer layer 430 may be formed on the first surface 412 of the first substrate 410.

When being formed of one monomer, the siloxane-based monomer layer 430 is formed to have a thickness of about 1 nm. The siloxane-based monomer layer 430 may be formed of linear chain monomers. When being formed of about 30 linear chains, the siloxane-based monomer layer 430 may be formed to have a thickness of about 30 nm. When the siloxane-based monomer layer 430 has a thickness greater than 30 nm, polymer properties are revealed and a deformation of the structure 400 may occur due to a difference of thermal expansion coefficients between the siloxane-based monomer layer 430 and the first substrate 410 and the second substrate 420 which will be described later.

Referring to FIG. 4D, a surface 431 of the siloxane-based monomer layer 430 is treated with oxygen plasma. The surface treatment may be performed using power of about 25 W. A plurality of second dangling bonds 442 are formed on the surface 431 of the siloxane-based monomer layer 430.

Referring to FIG. 4E, a second substrate 420 is prepared. The second substrate 420 includes a non-silicon-based substrate 418 and a first layer 419. The first layer 419 may be formed by depositing one of silicon and silicon oxide on the non-silicon-based substrate 418. As a deposition method, it is possible to use PVD such as sputtering and evaporation and CVD. While performing CVD, hydrogen may be generated on a surface of the second substrate 420, and thus, a thermal treatment may be further performed at a temperature of 400° C. or more to remove the hydrogen. The non-silicon-based substrate 418 may be formed of Group III-V semiconductors, metal, or plastic.

While disposing a contact surface that is a second surface 422 of the second substrate 420 to face the first surface 412 of the first substrate 410, mechanical pressure is applied to the first substrate 410 and the second substrate 420 in a direction shown by the arrows in a vacuum state of about 2 mtorr to bond them to each other. The mechanical pressure may be applied for an hour at a force of about 100 N. While bonding in the vacuum state, it is possible to prevent or inhibit bubbles from being formed between the first substrate 410 and the second substrate 420.

On the other hand, the second surface 422 of the second substrate 420 is previously treated with oxygen plasma to previously form a plurality of third dangling bonds on the second surface 422 and then the above bonding process may be performed.

Referring to FIG. 4F, a resultant structure is disposed at room temperature for 24 hours or at a temperature of 80° C. for an hour to be cured. In the curing process, the second dangling bonds 442 are strongly covalently bonded to the second substrate 420. The first substrate 410 and the second substrate 420 are bonded to each other by the siloxane-based monomer layer 430 therebetween, thereby manufacturing the bonded substrate structure 400 using a siloxane-based monomer.

It should be understood that the example embodiments described herein should be considered in a descriptive sense only and not for purposes of limitation. Descriptions of features or aspects within each embodiment should typically be considered as available for other similar features or aspects in other embodiments.

What is claimed is:

1. A bonded substrate structure comprising:
a siloxane-based monomer layer between a first substrate and a second substrate, the siloxane-based monomer layer bonding the first substrate and the second substrate.

2. The structure of claim 1, wherein the siloxane-based monomer layer is one of dimethyl siloxanes, methyl-phenyl siloxanes, and methyl-vinyl siloxanes.

3. The structure of claim 1, wherein the siloxane-based monomer layer has a thickness of from about 1 to about 30 nm.

4. The structure of claim 1, further comprising:
a plurality of first dangling bonds on a first surface of the first substrate, the plurality of first dangling bonds being bonded to the siloxane-based monomer layer; and
a plurality of second dangling bonds on one of a surface of the siloxane-based monomer and a second surface of the second substrate, the plurality of second dangling bonds being bonded to the siloxane-based monomer and the second substrate,
wherein the plurality of first dangling bonds and the plurality of second dangling bonds are formed by oxygen plasma.

5. The structure of claim 1, wherein the first substrate and the second substrate are one of a silicon substrate and a silicon oxide substrate.

6. The structure of claim 1, wherein at least one of the first substrate and the second substrate includes one of a silicon layer and a silicon oxide layer on a surface thereof.

7. The structure of claim 6, wherein the at least one of the first substrate and the second substrate includes one of Group III-V semiconductors, metal, and plastic.

8. A method of manufacturing a bonded substrate structure, the method comprising:
forming a plurality of first dangling bonds on a first surface of a first substrate using a surface treatment process;
applying a siloxane liquid onto the first surface;
cleaning the first surface to form a siloxane-based monomer layer bonded to the plurality of first dangling bonds on the first surface;
forming a plurality of second dangling bonds on one of a surface of the siloxane-based monomer layer and a second surface of a second substrate; and
bonding the second substrate to the siloxane-based monomer layer.

9. The method of claim 8, wherein the forming a plurality of first dangling bonds comprises treating the first surface with oxygen plasma.

10. The method of claim 8, wherein the applying a siloxane liquid comprises applying at least one of dimethyl siloxanes, methyl-phenyl siloxanes, and methyl-vinyl siloxanes.

11. The method of claim 8, wherein the applying a siloxane liquid further comprises curing the siloxane liquid.

12. The method of claim 8, wherein the forming a plurality of second dangling bonds on the surface of the siloxane-based monomer layer comprises treating the surface of the siloxane-based monomer layer with oxygen plasma.

13. The method of claim 8, wherein the forming a plurality of second dangling bonds on the second surface of the second substrate comprises treating the second surface of the second substrate with oxygen plasma.

14. The method of claim 8, wherein the bonding comprises applying mechanical pressure to the first substrate and the second substrate in a vacuum chamber.

15. The method of claim 8, wherein
the forming a plurality of first dangling bonds on a first surface of a first substrate includes forming the plurality of first dangling bonds on the first surface of one of a silicon substrate and a silicon oxide substrate, and
the bonding the second substrate includes bonding the siloxane-based monomer layer to one of the silicon substrate and the silicon oxide substrate.

16. The method of claim 8, wherein
the forming a plurality of first dangling bonds on a first surface of a first substrate includes forming the plurality of first dangling bonds on one of a silicon layer and a silicon oxide layer on a top surface of the first substrate, and
the bonding the second substrate includes bonding the siloxane-based monomer layer to one of the silicon layer and the silicon oxide layer on a top surface of the second substrate.

17. The method of claim 16, wherein
the forming a plurality of first dangling bonds on a first surface of a first substrate includes forming the plurality of first dangling bonds on the first surface of one of a Group III-V semiconductor substrate, metal substrate, and plastic substrate, and
the bonding the second substrate includes bonding the siloxane-based monomer layer to one of the Group III-V semiconductor substrate, the metal substrate, and the plastic substrate.
